(19) United States
(12) Patent Application Publication
(10) Pub. No.: US 2011/0139809 A1
(43) Pub. Date: Jun. 16, 2011

(54) Automated hot food vending machine for pre-packaged food articles

(76) Inventors: O'Neil K. Sawh, Temecula, CA (US); Mark Hoyt, Murrieta, CA (US)

(21) Appl. No.: 12/321,375

(22) Filed: Jan. 16, 2009

Related U.S. Application Data
(60) Provisional application No. 61/022,010, filed on Jan. 18, 2008.

(51) Int. Cl. G07F 9/10

(52) U.S. Cl. 221/150 A

(57) ABSTRACT

An automated pre-packaged hot food vending machine is equipped with an unattended microwave cooking and vending system that is capable of quickly cooking a large variety of frozen or refrigerated pre-packaged food items that utilizes a gravity delivery system, which reduces the amount of parts needed to operate the vending machine thereby reducing the overall machines malfunction and repair. The overall invention of the automated, pre-packaged hot food vending machine achieves its objectives by automatically cooking and delivering a variety of pre-packaged food items, such as pizza, hot dogs, hamburgers, sandwiches, desserts, etc. that were previously frozen or refrigerated within the vending machine, to users of the machine that purchase and select such items.

The automated pre-packaged hot food vending machine consists of a vending machine, a front door, the multi level, motorized spiral vending channels which hold the pre-packaged food items, a refrigeration cooling unit, a funnel delivery system, an automated microwave cooking system with upper and lower retractable door assemblies and a main controller board which operates the invention.

### RELATED APPLICATIONS

The present application claims the benefit of priority to U.S. Provisional Patent Application Ser. No. 61/022,010, for an invention entitled “Automated Pre-Packaged Hot Food Vending Machine” by the same inventors, which was filed Jan. 18, 2008, and currently co-pending.

### FIELD OF THE INVENTION

The present invention relates generally to the field of vending machines. The present invention is more particularly, though not exclusively, related to a vending machine with having a cooling device to maintain a variety of refrigerated food products, and one or more cooking cycles for cooking the variety of refrigerated food products to be sold to a customer.

### BACKGROUND OF THE INVENTION

In this day and age, regardless of the time of day, food is almost always available. With the on-the-go lifestyles, there is a constant demand for convenient and fast food sources. For instance, one can hardly drive a mile without passing at least two 24-Hour mini marts, all stocked to the ceiling with ready-to-eat snack foods. Some mini marts even have pre-cooked items, such as hotdogs and hamburgers. An alternative to the drive-in mini marts is the enormous variety of fast food restaurants, most having easy drive-through convenience.

As the demand for convenient and fast food sources has migrated indoors, many organizations have started providing vending machines that are accessible around the clock and filled with snack foods. These vending machines can dispense a variety of snack foods, soda, cigarettes, gum, fruit and candy. Also, some vending machines are configured to dispense cold sodas, or hot drinks such as coffee, hot cocoa, tea. Other vending machines are configured to store and dispense frozen foods, such as ice cream and popsicles, or refrigerated food, such as chilled sandwiches, milk, and fresh-cut vegetables.

These machines have several benefits. For instance, they are unmanned, and as a result, they are affordable to operate, may be placed in remote locations away from kitchens, dining rooms, cafeterias, and the like. In fact, because typical vending machines are coin-operated and dispense snacks automatically, they are often found in stairwells, patios, and hallways where passersby can easily stop, deposit some change, and quickly select a food item to take with them on the go.

Over the years, vending machines have become more and more complicated. For instance, modern machines have a contained supply of food, and a food dispensing mechanism for dispensing a single package or portion of the selected food product for each activation of the machine. Some of the more complicated mechanisms include various trap doors that can easily malfunction or jam, and as a result, render the vending machine totally inoperable which results in the loss of revenue to the vending machine owner.

While the vending machines have become popular in many environments, the available food products typically consist of items that are edible at room temperature. Some others may offer cooled food or drink products, and are dispensed from a storage chamber in the machine that is chilled through refrigeration techniques. However, to date there is a lack of vending machines that dispense hot food for consumption.

In light of the above, it would be advantageous to provide a vending machine product that stores food product, and then once a food choice is selected, heats and dispenses the heated food product automatically. It would also be advantageous to provide a vending machine that can store food product in a chilled or frozen state, and then heat that food product and dispense it for consumption.

### SUMMARY OF THE INVENTION

The present invention includes an automated pre-packaged hot food vending machine. The vending machine 12 is completely automated and is equipped with an unattended microwave cooking and vending system that is capable of quickly cooking a large variety of frozen or refrigerated pre-packaged food items that utilizes a gravity delivery system, which reduces the amount of parts needed to operate the vending machine thereby reducing the overall machines malfunction and repair.

The overall invention of the automated, pre-packaged hot food vending machine achieves its objectives by automatically cooking and delivering a variety of pre-packaged food items, such as pizza, hot dogs, hamburgers, sandwiches, desserts, etc. that were previously frozen or refrigerated within the vending machine, to users of the machine that purchase and select such items.

The automated pre-packaged hot food vending machine 10 consists of a vending machine 12, a front door 14, the multi level, motorized spiral vending channels 16 which hold the pre-packaged food items 28, a refrigeration cooling unit 18, a funnel delivery system 20, an automated microwave cooking system 22 with upper and lower retractable door assemblies 24a, 246, and a main controller board 32 which operates the invention.

Various objects, features, aspects and advantages of the present invention will become more apparent from the following detailed description of preferred embodiments of the invention, along with the accompanying drawings.

### BRIEF DESCRIPTION OF THE DRAWINGS

FIG. 1: is a front elevation view as seen from the outside of the front door 14 of the vending machine 12 of the invention 10;

FIG. 2: is a front view as seen from the inside 12b of the main body of the vending machine 12 of the invention 10;

FIG. 3: is a front view of the refrigeration temperature control panel 26;

FIG. 4: is a perspective view of the motorized spiral vending channels 16;

FIG. 5: is a perspective view of the funnel delivery chute 20;

FIG. 6: is a schematic cross section, view showing the funnel delivery cute 20 and the microwave cooking system 22;

FIG. 7: is a schematic diagram of the main controller board 32; and

FIG. 8: is a flow chart showing the operation of the present invention.

### REFERENCE DESIGNATOR LISTING

12: is the overall vending machine of the invention 10.
12a: are the legs of the vending machine 12 of the invention 10.
12b: is the inside of the vending machine 12 of the invention 10.
14: is the outside portion of the front door of the vending machine 12 of the invention 10.
14a: is the video display monitor.
14b: is the user LCD.
14c: is the bill currency/credit-debit card acceptor.
14d: is the T-handle cylinder key lock.
14e: is the coin insert slot and coin release button.
14f: are the displayed food items w/ associated buttons.
14g: is the food delivery opening.
14h: is the coin change opening.
16: are the multi-level, motorized, spiral vending channels.
16a: are the channels.
16b: are the motorized spirals.
16c: are the openings in the end of the channels 16a.
18: is the refrigeration cooling unit.
20: is the funnel delivery chute.
20a: are the rollers that direct the pre packaged food item 28 to the opening to the microwave cooking system 22.
20b: is the opening in the bottom of the funnel delivery chute 20 to microwave cooking system 22.
22: is the microwave cooking system.
22a: is the motor and electronics of the microwave cooking system 22.
22b: is the electronic circuit board which controls the retractable doors 24a, 24b and the cooking operation.
24a: is the upper retractable door assembly.
24b: is the lower retractable door assembly.
26: is the refrigeration temperature control panel.
26a: is the LCD read out panel.
26b: is the data entry key pad.
26c: is the command entry panel.
26d: is the 70 pin connector.
28: is the pre packaged food item.
30a: is the infrared motion sensor which activates upper retractable door assembly 24a.
30b: is the infrared motion sensor which activates timed cooking process.
30c: is the infrared motion sensor which activates lower retractable door assembly 24b.
32: is the main controller board.
32a: is the 4×40 L VD display.
32b: are the food tray motors and switches.

### DETAILED DESCRIPTION OF A PREFERRED EMBODIMENT

The present invention relates to a hot food vending machine that cooks a variety of frozen or refrigerated pre-packaged food items by way of an automated microwave cooking system, and delivers such items by way of a gravity-based delivery system. The hot food vending machine achieves its objective by automatically cooking and delivering a variety of pre-packaged food items, such as pizza, hot dogs, hamburgers, sandwiches, desserts, and more, that were previously frozen or refrigerated within the machine, to users of the machine that purchase and select such items.

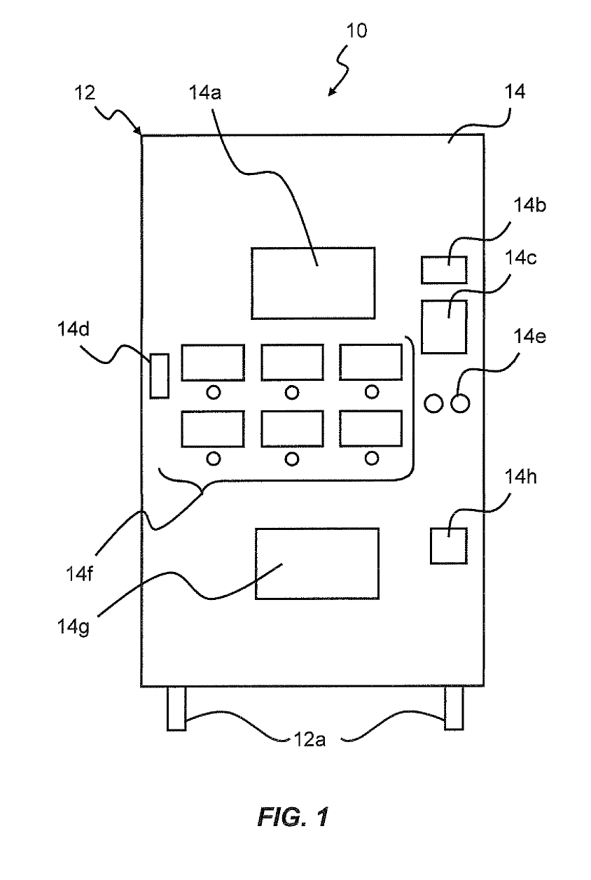

The front door of the machine [FIG. 1] can be constructed of any type of metal, including steel, aluminum or titanium; and contains (1) a video display monitor [FIG. 1, Number 14a] used strictly for visual advertising purposes, which does not relate to the operational process of the hot food vending machine and is an optional addition to the machine, (2) a user liquid crystal display (“LCD”) monitor [FIG. 1, Number 14b] that functions as a guide to the user, which informs them of the status of their payment and the cooking process of the machine, (3) a bill currency/credit-debit card acceptor [FIG. 1, Number 14c] that is used to process and authenticate user payments, (4) a “T” handle cylinder key lock [FIG. 1, Number 14d] that securely fastens the front door of the machine to the body of the machine and locks said door shut, (5) a section of displayed food items with associated buttons available for user selection [FIG. 1, Number 14f] that the user will view to identify and select the food item they desire to be cooked by the machine, which will be achieved by depressing the button specific to the food item selected, (6) a coin insert slot and coin release button [FIG. 1, Number 14e] whereas the coin insert slot gives the user the option of using coins as form of payment, or portion of payment, and the coin release button can be depressed by the user if the user wishes for their coins to be returned before total payment is fully processed, (7) the coin change opening [FIG. 1, Number 14h] where coin currency will be dispensed as change, when applicable, (8) the food delivery opening [FIG. 1, Number 14g] where food items selected by users are delivered once the cooking process is completed.

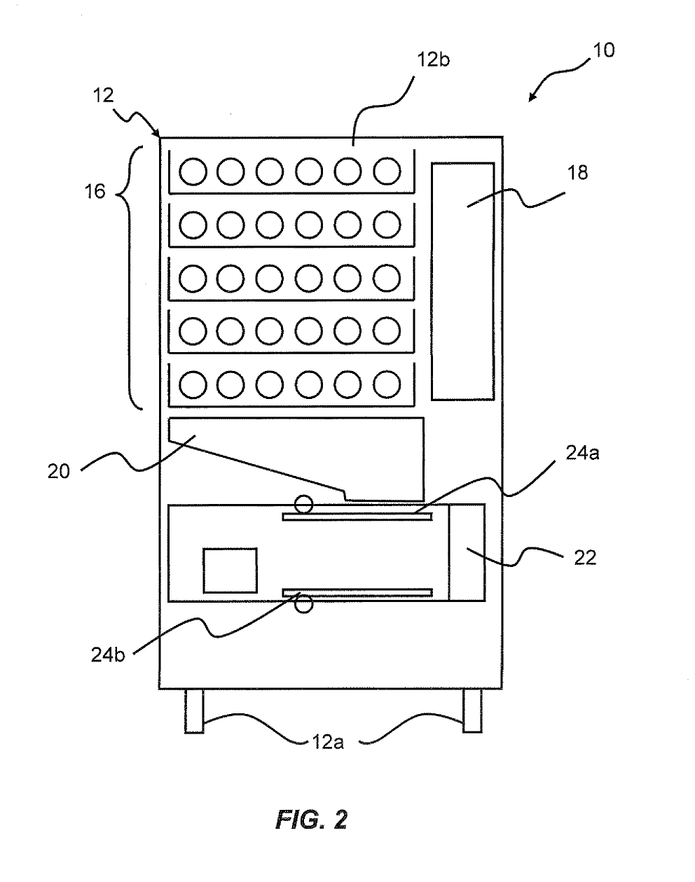

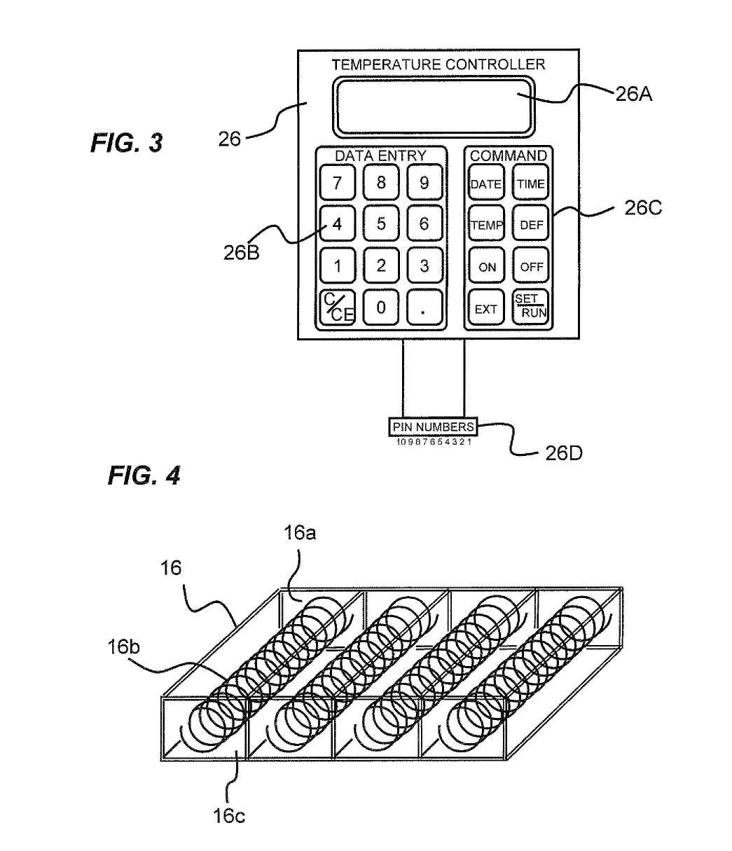

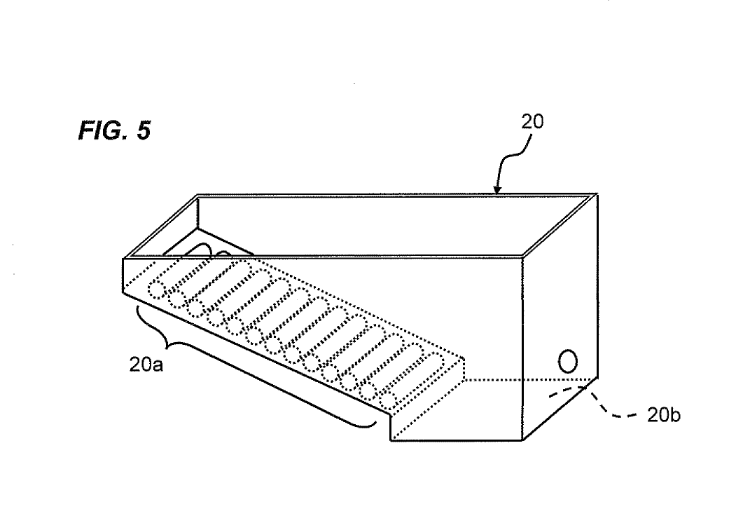

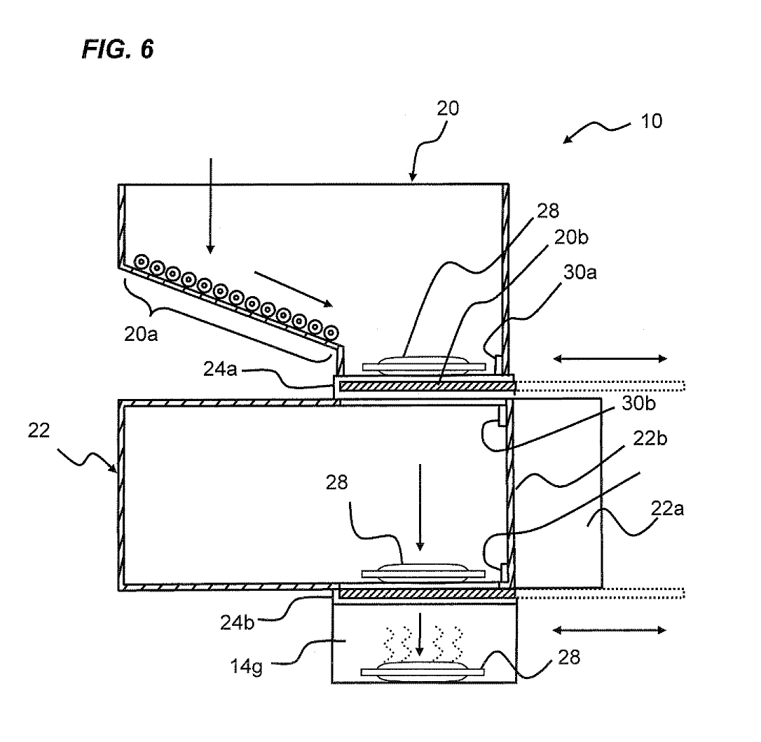

The body of the machine can be constructed of any type of metal, including steel, aluminum or titanium. The inside of the body of the machine [FIG. 2] contains (1) a refrigeration cooling unit [FIG. 2, Number 18] with a temperature programmable liquid crystal display (“LCD”) control panel [FIG. 3] used to keep frozen or refrigerated the pre-packaged food items at a specifically programmed temperature, (2) a section of multi-level motorized spiral vending channels [FIG. 2, Number 16; and FIG. 4] wherein the pre-packaged food items are stored in-between said spiral channels [FIG. 4, Numbers 16a and 16b], (3) a funnel delivery chute [FIG. 2, Number 20] with optional cylindrical rolling devices [FIG. 5, Number 20a] used to deliver food items to the microwave cooking system [FIG. 5, Number 20b; and FIG. 6, Number 20b], and (4) a microwave cooking system [FIG. 2, Number 22; and FIG. 6, Number 22] with motorized retracting dual doors at the top and bottom of said microwave [FIG. 2, Numbers 24a and 24b; and FIG. 6, Numbers 24a and 24b].

The user of the machine first inserts payment through the bill currency/credit-debit card acceptor [FIG. 1, Number 14c] and/or coin insert slot [FIG. 1, Number 14e] where their payment is authenticated by said devices. Once payment has been properly authenticated, the user then receives instructions via the user LCD monitor [FIG. 1, Number 14b] to select the pre-packaged food item of their choice from the selection of displayed food items available [FIG. 1, Number 14f]. Once the user selects the food item of their choice, the user LCD notifies the user that the cooking process has begun.

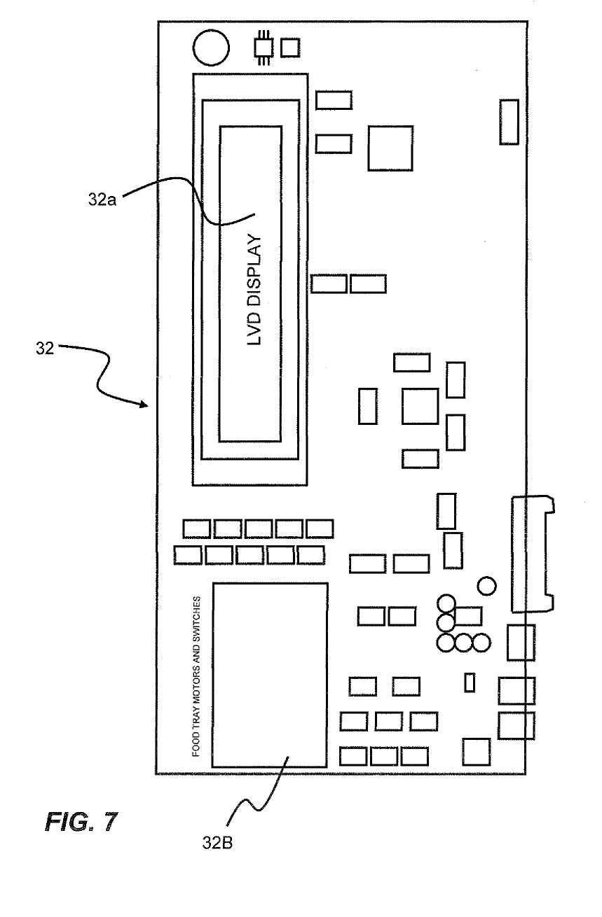

The user's selection of a food item is achieved by depressing the button nearest to the specific food item of their choice from the section of displayed food items and associated buttons. Once said button is depressed, the main controller circuit board of the machine [FIG. 7], which controls the operation and integration of all automated vending processes, and can be affixed by bolting or otherwise anywhere within the inside of the body of the machine, receives the related signal and in turn sends a signal to the motor connected to the spiral vending channel wherein the desired food item is stored, which activates the motor and dispenses, through the use of gravity, the desired food item into the funnel delivery chute [FIG. 2, Number 20; and FIG. 5].

The funnel delivery chute then delivers the desired food item [exampled by FIG. 28] to the top motorized retracting door of the microwave cooking system [FIG. 6, Number 24a] where said food item is detected by an infrared motion sensor [FIG. 6, Number 30a] that triggers the top door of the microwave to automatically open/retract, in a horizontal fashion, causing the desired food item to fall into the cooking cavity of the microwave. Two infrared motion sensors inside the cooking cavity of the microwave [FIG. 6, Numbers 30b and 30c] then trigger the top door of the microwave to automatically retract back sealing the cooking cavity securely shut, which initiates a pre-set timed cooking interval as pre-set by the main controller circuit board of the machine.

Once the timed cooking process is complete, the bottom door of the microwave [FIG. 6, Number 24b] automatically opens/retracts, in a horizontal fashion, causing the desired, fully cooked, pre-packaged food item to fall into the food delivery opening of the machine [FIG. 1, Number 14g, and FIG. 6, Number 14g] for delivery to and consumption by the user who selected said food item.

While the present invention has been described in terms of specific embodiments, it is to be understood that the invention is not limited to these disclosed embodiments. This invention may be embodied in many different forms and should not be construed as limited to the embodiments set forth herein; rather, these embodiments are provided by way of illustration only and so that this disclosure will be thorough, complete and will fully convey the full scope of the invention to those skilled in the art. Indeed, many modifications and other embodiments of the invention will come to mind of those skilled in the art to which this invention pertains, and which are intended to be and are covered by both this disclosure, the drawings and the claims.

The automated pre-packaged hot food vending machine can be used in any commercial establishment or public facility.

A large mechanical device comprising a metal cubic rectangular body with a proportional hinge fastened metal front door, which contains, on the front door, a main controller circuit board, a video display monitor, a liquid crystal display (“LCD”) monitor, a bill currency/credit-debit card acceptor, a “T” handle cylinder key lock, a section of displayed food items with associated buttons, a coin insert slot and coin release button, a coin change opening, and a food delivery opening; and contains, within the body of the device, a refrigeration cooling unit, a section of multi-level motorized spiral vending channels, a funnel delivery chute, and a microwave cooking system, wherein all aforementioned components are assembled according to the drawings incorporated herein and work together, electronically, by way of direction from the main controller circuit board, to achieve its objective of creating a completely automated and unattended microwave cooking vending system capable of quickly cooking a large variety of frozen or refrigerated pre-packaged food items that utilizes a simply gravity delivery system and unique microwave design, which reduces the amount of parts and components needed to assemble and operate the machine thereby reducing overall machine malfunction and repair.

The automated pre-packaged hot food vending machine is a completely unattended microwave cooking vending system capable of quickly cooking a large variety of frozen or refrigerated pre-packaged food items, such as pizza, hot dogs, hamburgers, sandwiches, desserts, and more. The machine's simple gravity delivery system and unique microwave design reduces the amount of parts and components needed to assemble and operate the machine thereby reducing overall machine malfunction and repair. The gravity delivery system utilizes basic gravity by having the pre-packaged food items fall from the motorized spiral vending channels into the funnel delivery chute, and then into the microwave. The microwave itself is unique because of its motorized retracting doors, with motion sensor technology, on the top and bottom of the microwave, which further utilizes gravity to delivery the pre-packaged food items into the microwave for cooking, and out for delivery to the user for consumption.

### Operation of a Preferred Embodiment

Referring now to FIG. 8, a flow chart showing the operation of the automated hot food vending machine for pre-packaged food articles is shown. The operation starts when a deposit is received from a customer, such as in the form of coins, dollar bills, or in some cases, a debit, credit, or money transfer card. The Customer then selects a food product from the food product dispenser. The selected food product is then dispenses from the food product dispenser and is gravity directed onto an upper door of a microwave chamber. The food product is detected, such as by infrared or motion sensing electronics.

Once the food product is detected, the upper door to the microwave chamber is opened. This door continues to open until it is open all the way providing sufficient space for the selected food product to fall into the microwave chamber. Once fully opened, the upper door closes.

After the upper door is closed, the microwave emitter is activated for a predetermined period of time based on the particular food product selected. For instance, a Hamburger may require 75 seconds of cook-time, while a burrito may require 100 seconds of cook time.

Once the cook time has passed, the lower door is opened to dispense the food product to the customer. The lower door opens all the way to allow the customer go retrieve his now-heated product. Once the door is open all the way, it then closes. Once closed, the automated hot food vending machine for pre-packaged food articles is ready for the next transaction.

Specific embodiments and applications of an automated hot food vending machine for pre-packaged food articles have been disclosed. It should be apparent, however, to those skilled in the art that many more modifications besides those already described are possible without departing from the inventive concepts herein. Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

We claim:

1. an automated hot food vending machine for pre-packaged food articles, comprising:
a food article storage chamber capable of storing a plurality of food articles;
a means for retrieving one said food article from said storage chamber;
a means for heating said food article; and
a means for dispensing said heated food article.
